(19) United States
(12) Patent Application Publication
(10) Pub. No.: US 2022/0317898 A1
(43) Pub. Date: Oct. 6, 2022

(54) Managing Application Storage Resource Allocations Based on Application Specific Storage Policies

(71) Applicant: EMC IP HOLDING COMPANY LLC, Hopkinton, MA (US)

(72) Inventors: Brian O'Halloran, Carrigaline (IE); Warren Fleury, Ballincollig (IE)

(21) Appl. No.: 17/221,772

(22) Filed: Apr. 3, 2021

(51) Int. Cl. G06F 3/06

(52) U.S. Cl. CPC G06F 3/0631; G06F 3/0653; G06F 3/0644; G06F 3/0605; G06F 3/067

(57) ABSTRACT

Applications that are configured to use storage resources of a storage system are associated with application specific storage policies. The storage policies define the size of devices to be created on the storage system for use by the application and storage usage percentage thresholds for determining when storage expansion events should occur. The storage policies also specify storage expansion parameters which are used, when a storage expansion event occurs, to specify the manner in which the storage expansion events should be implemented on the storage system. Example storage expansion parameters include expansion trigger parameters, the type of storage expansion, and the value by which the storage expansion should be implemented. A compliance engine is instantiated on the storage system, which compares application storage usage with application storage policies, and executes automatic expansion events to prevent applications from running out of storage resources on the storage system.

### FIELD

This disclosure relates to computing systems and related devices and methods, and, more particularly, to managing application storage resource allocations based on application specific storage policies.

### SUMMARY

The following Summary and the Abstract set forth at the end of this document are provided herein to introduce some concepts discussed in the Detailed Description below. The Summary and Abstract sections are not comprehensive and are not intended to delineate the scope of protectable subject matter, which is set forth by the claims presented below.

All examples and features mentioned below can be combined in any technically possible way.

Applications that are configured to use storage resources of a storage system are associated with application specific storage policies. The storage policies define the size of devices to be created on the storage system for use by the application and storage usage percentage thresholds for determining when storage expansion events should occur. The storage policies also specify storage expansion parameters which are used, when a storage expansion event occurs, to specify the manner in which the storage expansion events should be implemented on the storage system. Example storage expansion parameters include expansion trigger parameters, the type of storage expansion, and the value by which the storage expansion should be implemented. A compliance engine is instantiated on the storage system, which compares application storage usage with application storage policies, and executes automatic expansion events to prevent applications from running out of storage resources on the storage system.

### BRIEF DESCRIPTION OF THE DRAWINGS

FIG. 1 is a functional block diagram of an example storage system connected to a host computer, according to some embodiments.

FIG. 2 is a functional block diagram of an example storage system management application configured to manage application storage resource allocations based on application specific storage policies, according to some embodiments.

FIG. 3 is an example application storage policy identifier data structure, correlating application identifiers with storage policy identifiers, according to some embodiments.

FIG. 4 is an example storage policy data structure, correlating storage policy identifiers with storage policy parameters, according to some embodiments.

FIG. 5 is an example application storage policy data structure, correlating application identifiers with storage policy parameters, according to some embodiments.

FIG. 6 is a functional block diagram providing additional details associated with an example storage resource pool storage policy parameter, according to some embodiments.

FIG. 7 is a functional block diagram providing additional details associated with an example device size storage policy parameter, according to some embodiments.

FIG. 8 is a functional block diagram providing additional details associated with example capacity monitoring parameters and storage expansion parameters, according to some embodiments.

FIG. 9 is a functional block diagram providing additional details associated with example storage expansion parameters, according to some embodiments.

FIG. 10 is a flow chart of an example method of detecting compliance of applications with assigned storage policies, and implementing automated storage allocation expansion events, according to some embodiments.

FIG. 11 is a graph of storage capacity vs time, showing a hypothetical application's usage of storage on a storage system and automatic expansion of the storage system's storage allocation, according to some embodiments.

### DETAILED DESCRIPTION

Aspects of the inventive concepts will be described as being implemented in a storage system 100 connected to a host computer 102. Such implementations should not be viewed as limiting. Those of ordinary skill in the art will recognize that there are a wide variety of implementations of the inventive concepts in view of the teachings of the present disclosure.

Some aspects, features and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory tangible computer-readable medium. Furthermore, it will be understood by those of ordinary skill in the art that the computer-executable instructions may be executed on a variety of tangible processor devices, i.e., physical hardware. For ease of exposition, not every step, device or component that may be part of a computer or data storage system is described herein. Those of ordinary skill in the art will recognize such steps, devices and components in view of the teachings of the present disclosure and the knowledge generally available to those of ordinary skill in the art. The corresponding machines and processes are therefore enabled and within the scope of the disclosure.

The terminology used in this disclosure is intended to be interpreted broadly within the limits of subject matter eligibility. The terms “logical” and “virtual” are used to refer to features that are abstractions of other features, e.g. and without limitation, abstractions of tangible features. The term “physical” is used to refer to tangible features, including but not limited to electronic hardware. For example, multiple virtual computing devices could operate simultaneously on one physical computing device. The term “logic” is used to refer to special purpose physical circuit elements, firmware, and/or software implemented by computer instructions that are stored on a non-transitory tangible computer-readable medium and implemented by multi-purpose tangible processors, and any combinations thereof.

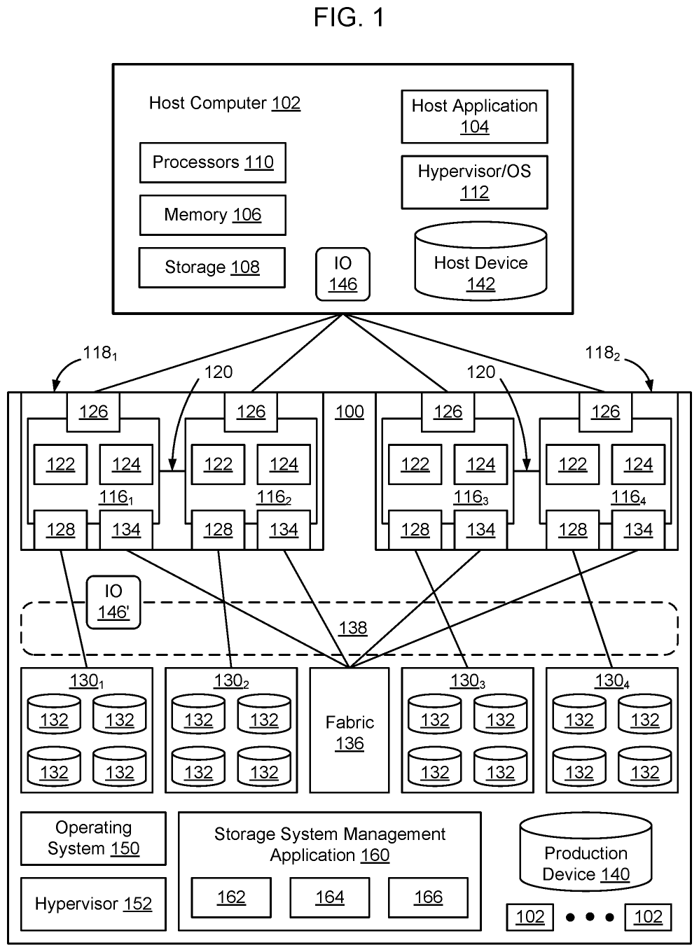

FIG. 1 illustrates a storage system 100 and an associated host computer 102, of which there may be many. The storage system 100 provides data storage services for a host application 104, of which there may be more than one instance and type running on the host computer 102. In the illustrated example, the host computer 102 is a server with host volatile memory 106, persistent storage 108, one or more tangible processors 110, and a hypervisor or OS (Operating System) 112. The processors 110 may include one or more multi-core processors that include multiple CPUs (Central Processing Units), GPUs (Graphics Processing Units), and combinations thereof. The host volatile memory 106 may include RAM (Random Access Memory) of any type. The persistent storage 108 may include tangible persistent storage components of one or more technology types, for example and without limitation SSDs (Solid State Drives) and HDDs (Hard Disk Drives) of any type, including but not limited to SCM (Storage Class Memory), EFDs (Enterprise Flash Drives), SATA (Serial Advanced Technology Attachment) drives, and FC (Fibre Channel) drives. The host computer 102 might support multiple virtual hosts running on virtual machines or containers. Although an external host computer 102 is illustrated in FIG. 1, in some embodiments host computer 102 may be implemented as a virtual machine within storage system 100.

The storage system 100 includes a plurality of compute nodes 116₁-116₄, possibly including but not limited to storage servers and specially designed compute engines or storage directors for providing data storage services. In some embodiments, pairs of the compute nodes, e.g. (116₁-116₂) and (116₃-116₄), are organized as storage engines 118₁ and 118₂, respectively, for purposes of facilitating failover between compute nodes 116 within storage system 100. In some embodiments, the paired compute nodes 116 of each storage engine 118 are directly interconnected by communication links 120. As used herein, the term “storage engine” will refer to a storage engine, such as storage engines 118₁ and 118₂, which has a pair of (two independent) compute nodes, e.g. (116₁-116₂) or (116₃-116₄). A given storage engine 118 is implemented using a single physical enclosure and provides a logical separation between itself and other storage engines 118 of the storage system 100. A given storage system 100 may include one storage engine 118 or multiple storage engines 118.

Each compute node, 116₁, 116₂, 116₃, 116₄, includes processors 122 and a local volatile memory 124. The processors 122 may include a plurality of multi-core processors of one or more types, e.g. including multiple CPUs, GPUs, and combinations thereof. The local volatile memory 124 may include, for example and without limitation, any type of RAM. Each compute node 116 may also include one or more front end adapters 126 for communicating with the host computer 102. Each compute node 116₁-116₄ may also include one or more back-end adapters 128 for communicating with respective associated back-end drive arrays 130₁-130₄, thereby enabling access to managed drives 132. A given storage system 100 may include one back-end drive array 130 or multiple back-end drive arrays 130.

In some embodiments, managed drives 132 are storage resources dedicated to providing data storage to storage system 100 or are shared between a set of storage systems 100. Managed drives 132 may be implemented using numerous types of memory technologies for example and without limitation any of the SSDs and HDDs mentioned above. In some embodiments the managed drives 132 are implemented using NVM (Non-Volatile Memory) media technologies, such as NAND-based flash, or higher-performing SCM (Storage Class Memory) media technologies such as 3D XPoint and ReRAM (Resistive RAM). Managed drives 132 may be directly connected to the compute nodes 116₁-116₄, using a PCIe (Peripheral Component Interconnect Express) bus or may be connected to the compute nodes 116₁-116₄, for example, by an IB (InfiniBand) bus or fabric.

In some embodiments, each compute node 116 also includes one or more channel adapters 134 for communicating with other compute nodes 116 directly or via an interconnecting fabric 136. An example interconnecting fabric 136 may be implemented using InfiniBand. Each compute node 116 may allocate a portion or partition of its respective local volatile memory 124 to a virtual shared “global” memory 138 that can be accessed by other compute nodes 116, e.g. via DMA (Direct Memory Access) or RDMA (Remote Direct Memory Access). Shared global memory 138 will also be referred to herein as the cache of the storage system 100.

The storage system 100 maintains data for the host applications 104 running on the host computer 102. For example, host application 104 may write data of host application 104 to the storage system 100 and read data of host application 104 from the storage system 100 in order to perform various functions. Examples of host applications 104 may include but are not limited to file servers, email servers, block servers, and databases.

Logical storage devices are created and presented to the host application 104 for storage of the host application 104 data. For example, as shown in FIG. 1, a production device 140 and a corresponding host device 142 are created to enable the storage system 100 to provide storage services to the host application 104.

The host device 142 is a local (to host computer 102) representation of the production device 140. Multiple host devices 142, associated with different host computers 102, may be local representations of the same production device 140. The host device 142 and the production device 140 are abstraction layers between the managed drives 132 and the host application 104. From the perspective of the host application 104, the host device 142 is a single data storage device having a set of contiguous fixed-size LBAs (Logical Block Addresses) on which data used by the host application 104 resides and can be stored. However, the data used by the host application 104 and the storage resources available for use by the host application 104 may actually be maintained by the compute nodes 116₁-116₄ at non-contiguous addresses (tracks) on various different managed drives 132 on storage system 100.

In some embodiments, the storage system 100 maintains metadata that indicates, among various things, mappings between the production device 140 and the locations of extents of host application data in the virtual shared global memory 138 and the managed drives 132. In response to an IO (Input/Output command) 146 from the host application 104 to the host device 142, the hypervisor/OS 112 determines whether the IO 146 can be serviced by accessing the host volatile memory 106. If that is not possible then the IO 146 is sent to one of the compute nodes 116 to be serviced by the storage system 100.

There may be multiple paths between the host computer 102 and the storage system 100, e. g. one path per front end adapter 126. The paths may be selected based on a wide variety of techniques and algorithms including, for context and without limitation, performance and load balancing. In the case where IO 146 is a read command, the storage system 100 uses metadata to locate the commanded data, e.g. in the virtual shared global memory 138 or on managed drives 132. If the commanded data is not in the virtual shared global memory 138, then the data is temporarily copied into the virtual shared global memory 138 from the managed drives 132 and sent to the host application 104 by the front-end adapter 126 of one of the compute nodes 116₁-116₄. In the case where the IO 146 is a write command, in some embodiments the storage system 100 copies a block being written into the virtual shared global memory 138, marks the data as dirty, and creates new metadata that maps the address of the data on the production device 140 to a location to which the block is written on the managed drives 132. The virtual shared global memory 138 may enable the production device 140 to be reachable via all of the compute nodes 116₁-116₄ and paths, although the storage system 100 can be configured to limit use of certain paths to certain production devices 140 (zoning).

Not all volumes of data on the storage system are accessible to host computer 104. When a volume of data is to be made available to the host computer, a logical storage volume, also referred to herein as a TDev (Thin Device), is linked to the volume of data, and presented to the host computer 104 as a host device 142. For example, to protect the production device 140 against loss of data, a snapshot (point in time) copy of the production device 140 may be created and maintained by the storage system 100. If the host computer 104 needs to obtain access to the snapshot copy, for example for data recovery, the snapshot copy may be linked to a logical storage volume (TDev) and presented to the host computer 104 as a host device 142. The host computer 102 can then execute read/write IOs on the TDev to access the data of the snapshot copy.

Applications are allocated storage capacity on the storage resources 130 of storage system 100. If an application exceeds its storage allocation, by sending too much data to the storage system to be stored, the application can run out of storage capacity. This can cause the execution of the application to be stopped, which can be costly from a business standpoint. Accordingly, monitoring application storage use and allocated capacity is a day-to-day task for data center administrators and application owners. Since hundreds or thousands of applications can use a particular storage system, and a data center may have multiple storage systems 100, managing this aspect of storage provisioning becomes increasingly difficult. Although the storage system administrators can spend time finding and solving capacity related problems in their data center(s), this is often a reactive investigation and resolution process, that occurs only after a problem has occurred, such as when a problem is brought to the system administrator's attention by the application users.

To prevent applications from exceeding storage allocations, according to some embodiments, an automated policy-based system is provided to aid in the creation of application storage allocations and storage allocation expansion operations, when the criteria of the policy are met. This proactive problem resolution makes for a smoother running of data center operations, by standardizing the size of devices created for applications and enabling different types of storage allocation expansion operations for different applications to be specified in advance.

By enabling the use of application storage policies, it is possible to standardize creation of devices for applications and significantly reduce the likelihood that a particular application will exceed its storage allocation. Although some implementations will be described in which a storage allocation policy is applied to a particular application, if that application happens to have sub-components, the same policy may be automatically applied to each of the sub-components depending on the implementation. Accordingly, it is possible to ensure that all sub-components of a given application likewise have consistent storage allocation policies and similarly configured storage devices on the storage system. In some embodiments, the storage allocation policies define where the devices will take their storage from (the storage resource pool on the storage system) and the default size of new devices. The policies also specify criteria for expanding application storage allocations and what level of autonomy to use.

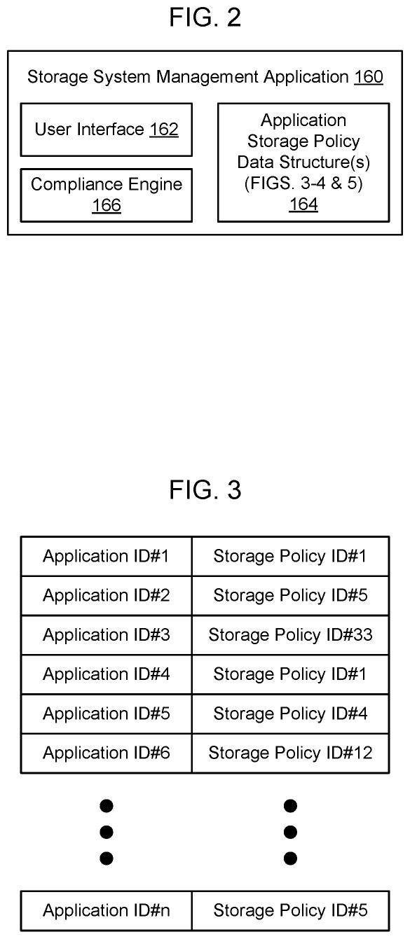

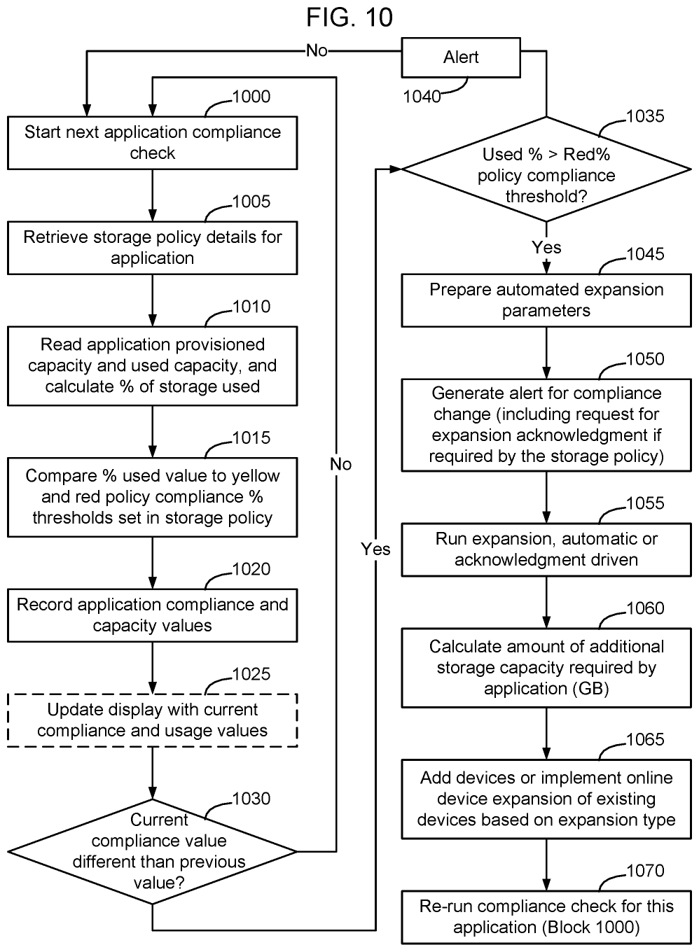

FIG. 2 is a functional block diagram of an example storage system management application configured to manage application storage resource allocations based on application specific storage policies, according to some embodiments. As shown in FIG. 2, in some embodiments the storage system management application 160 has a user interface 162 that a user can use to create storage policies and apply storage policies to applications. In some embodiments, the storage policies and application of storage policies to applications is implemented using one or more application/storage policy data structures 164, several examples of which are described in greater detail below in connection with FIGS. 3-4 and 5. Once the storage policies have been assigned to the applications, compliance with the storage policies is determined using compliance engine 166, as described in greater detail in connection with FIG. 10.

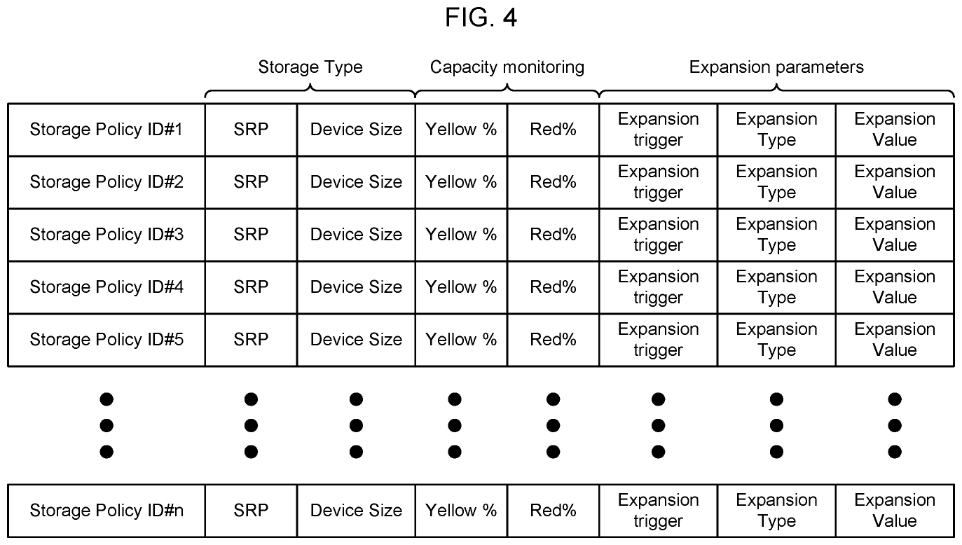

There may be multiple ways of creating storage policies and assigning storage policies to applications. In some embodiments, as shown in FIGS. 3-4, storage policies are created first, stored in a storage policy data structure (FIG. 4) and then pre-defined storage policies are assigned to applications (FIG. 3). Specifically, FIG. 3 is a functional block diagram of an example application storage policy identifier data structure, correlating application identifiers with storage policy identifiers, according to some embodiments. FIG. 4 is an example storage policy data structure, correlating storage policy identifiers with storage policy parameters, according to some embodiments.

In the embodiments shown in FIGS. 3-4, when an application is provisioned on the storage system 100, a storage policy is selected from the storage policy data structure (FIG. 4) and assigned to the application. The association is stored in the application storage policy identifier data structure (FIG. 3). Selecting pre-configured policies from the storage policy data structure (FIG. 4) has the advantage of enabling the same storage policy to be applied to multiple applications on the storage system 100.

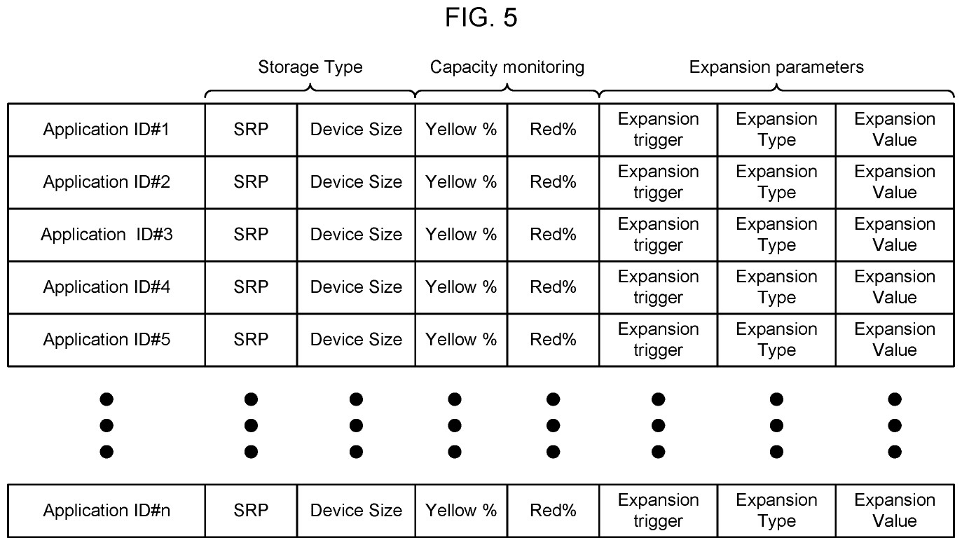

FIG. 5 is an example application storage policy data structure, correlating application identifiers with storage policy parameters, according to some embodiments. In the embodiment shown in FIG. 5, rather than using two separate data structures, a single data structure is used to correlate applications with storage policy parameters.

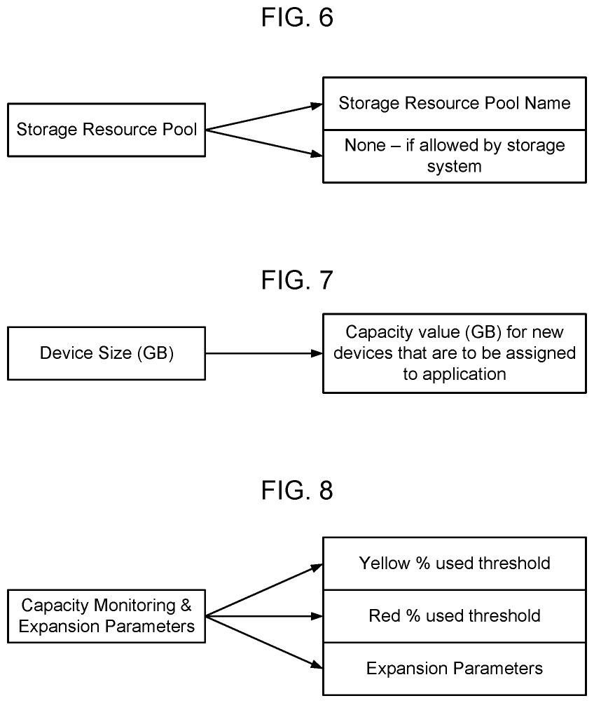

In some embodiments, the storage policy parameters include one or more parameters defining the type of storage that should be provided by the storage system 100 to the application 104. Example storage type parameters include the Storage Resource Pool (SRP) that should be used to create the storage devices, and the default size of the storage devices that should be created for the application. Additionally, in some embodiments, the storage policy parameters include storage capacity monitoring parameters, such as yellow and red percentage usage thresholds. Finally, in some embodiments, the storage policy parameters include expansion parameters defining how expansion events should be implemented if the storage allocation for the application needs to be increased. Each of these example storage policy parameters are described below in connection with FIGS. 6-9.

FIG. 6 is a functional block diagram providing additional details associated with an example storage resource pool storage policy parameter, according to some embodiments. A Storage Resource Pool (SRP), as that term is used herein, is a pool of physical storage on the storage system 100. For example, a set of managed drives 132 may be assigned by the storage system to implement a particular storage resource pool. Devices that are created for use by the application will use storage resources from the drives 132 that form the selected storage resource pool. Some storage systems 100 may enable the storage allocation policy to not specify a particular storage resource pool, i.e. by inserting “NONE” as the SRP option for a particular storage allocation policy. If no storage resource pool is specified, in the storage allocation policy, in some embodiments the storage system 100 will select an appropriate storage resource pool and create devices for the application from the collection of storage resources allocated to the selected storage resource pool.

FIG. 7 is a functional block diagram providing additional details associated with an example device size storage policy parameter, according to some embodiments. The “device size” parameter, as that term is used herein, is a capacity value specified in GB, TB, or another storage capacity value. Any new devices assigned to the application will be configured on the system to be the size of the “device size”. If the application is new, the starting capacity configuration for the application will be a multiple of this device size, depending on the number of devices required to fulfil the total requested capacity. If additional capacity is to be added to an existing application in connection with an expansion event, and the expansion event is specified by the policy to be implemented by adding additional devices to the application, each of the additional devices that are added during the expansion event will be configured to have the size specified in the “device size” storage allocation policy parameter.

For example, if an application is to be assigned 25 GB of storage capacity, and the device size is specified to be 5 GB, when the policy is applied to the application a total of 5 devices will be created, each with a capacity of 5 GB. It should be understood that, in some embodiments, the devices that are created are considered “thin” in that although the applications see the devices as having a fixed “device size”, which specifies the maximum amount of data that the application can store on the device, the actual storage resources consumed by the devices on managed drives 132 is based on the amount of data actually stored by the application on the storage system 100.

In some embodiments, the user will specify an initial allocation of storage to be allocated to an application when storage is created for the application on the storage system. The amount of storage specified during this initiation process defines the total volume of storage to be provided by the storage system to the application. The “device size” storage policy parameter is then used by the storage system to determine how many devices should be created for use by the application, to enable the storage system to fulfill its storage obligations.

FIG. 8 is a functional block diagram providing additional details associated with example capacity monitoring parameters and storage expansion parameters, according to some embodiments. As shown in FIG. 8, in some embodiments the capacity monitoring policy parameters include capacity thresholds, specified as percentages of allocated capacity, which specify when usage notifications and expansion events should occur.

In some embodiments, the yellow and red capacity thresholds are percentage values that are used to specify when alerts should be generated and when expansion events should occur. In some embodiments, the capacity thresholds are values that are set by the storage allocation policy, for example in a range between 1%-99%. Example thresholds could be, for example, yellow capacity threshold=75%; red capacity threshold=90%, although other values may be specified depending on the particular application use case scenario. In some embodiments, the value of the yellow % capacity threshold must be below the value of the red % capacity threshold.

In some embodiments, the yellow % capacity thresholds are used to generate alerts, such that a yellow capacity threshold breach will trigger an alert when the amount of storage used by an application first exceeds the yellow threshold. For example, if the yellow threshold is set in an application policy at 75% capacity, the first time the amount of storage being used by the application exceeds 75% of its allocated storage, an alert will be generated and displayed to the storage system administrator via the storage system management application 160 user interface 162. In some embodiments, the red % capacity threshold is used to specify when automatic expansion of the allocated storage capacity should be implemented.

When the compliance engine 166 determines that an expansion event should be implemented, for example by determining that the percentage of storage currently used by the application exceeds the red capacity threshold, the expansion parameters of the policy determine the manner in which the expansion event is implemented by the storage system 100.

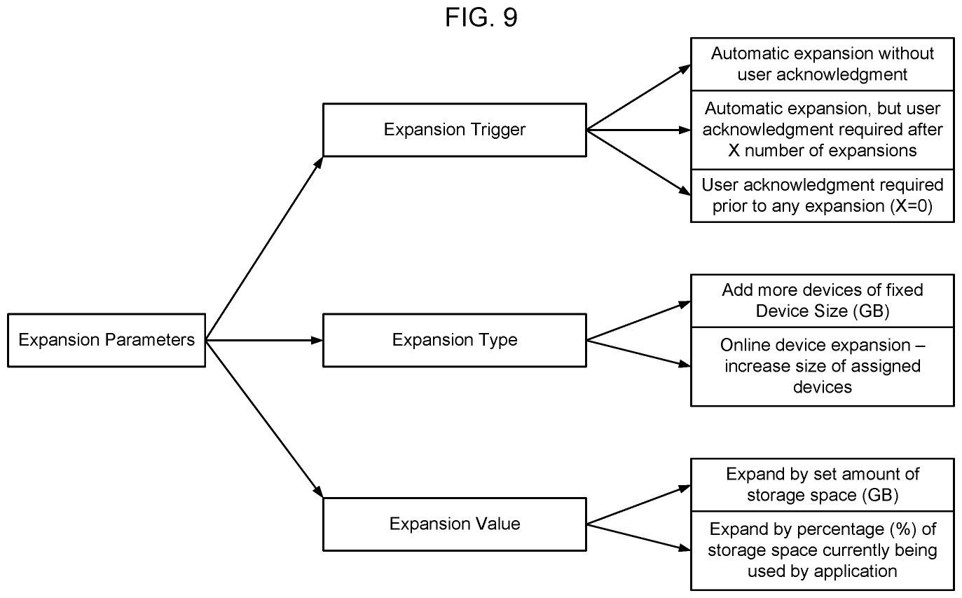

FIG. 9 is a functional block diagram providing additional details associated with example storage expansion parameters, according to some embodiments. The expansion parameters of an application storage policy specify behavior of the storage system in connection with execution of a storage expansion event, when the amount of storage used by an application exceeds the red % capacity threshold of the application storage policy. As shown in FIG. 9, in some embodiments the expansion parameters include expansion trigger parameters, which specify when expansion should occur, expansion type parameters, which specify the type of expansion that should occur, and an expansion value parameters, which specifies how much additional storage should be added to the application's storage allocation in connection with an expansion event.

In some embodiments, there are several types of expansion triggers. For example, as shown in FIG. 9, a first type of expansion trigger may be simply a determination that the amount of storage used by the application has exceeded the red % capacity threshold. In this instance, the storage system will execute an automatic expansion without requiring an user acknowledgment or authorization.

Another type of trigger event may require user acknowledgment that the expansion is to occur, before the storage system automatically implements a storage expansion process. A user may specify, via the expansion trigger parameter, that the storage system may automatically implement a storage expansion for a given number of times, but that user acknowledgment is required after the storage system has implemented storage expansion a predefined “X” number of times. Alternatively, “X” may be set to 0, to require user acknowledgment (permission) before any storage allocation expansion occurs for the application.

The “type of expansion” parameter defines how expansion should be implemented. FIG. 9 shows two example ways to expand the amount of storage resources allocated to an application during an expansion event. For example, as shown in FIG. 9, additional storage may be allocated to the application by adding more devices of the fixed “device size” or by doing an on-line expansion of the existing devices—by increasing the size of the previously created devices. The option for adding more devices will add the required number of extra devices of the capacity defined in the device size property (See FIG. 7). The device expansion property expands the size of the existing devices by the required amount to meet the expanded capacity.

The “expansion value” property specifies the amount that the storage system should expand the current storage allocation, each time an expansion event is required. In some embodiments, there are two expansion value options—expand by a fixed amount of storage, e.g. a fixed GB value, or expand by adding a percentage of the amount of storage currently being used by the application. If the expansion type is set to add more devices of fixed size, expanding by a fixed GB value will cause enough devices to be created to expand the amount of storage allocated to the application by at least that number of GB. For example, if the “device size” is set to 5 GB, and the “expand by” value is 12 GB, the storage system will create three new devices each time an expansion event occurs. Likewise, expanding by a percentage of application size will add enough devices to expand the amount of storage allocated to the application by at least the “expand by” percentage of GB of the current application capacity.

Once the storage policy has been defined and assigned to the application, the storage system management application will periodically monitor the application for compliance with the storage allocation policy. In particular as shown in FIG. 2, in some embodiments the storage system management application 160 includes a compliance engine 166 configured to monitor application storage usage and application compliance with storage application policies, and trigger automatic expansion events to prevent the applications from running out of storage resources on storage system 100.

In some embodiments, the storage policies are used, at regular intervals, to compare the current amount of storage used by the applications relative to the overall available amount of storage allocated to the applications. As the amount of storage reaches the yellow and red percentage capacity thresholds, defined by the application specific storage policies, compliance of the application with the storage policies will change. The system then automatically, or after user acknowledgement, expands the storage allocated on the storage system 100, to increase the amount of storage that is allocated to the application.

All applications on the storage system 100 are checked, and the ones which have configuration policies assigned to them have compliance checks run against them. It is possible to have applications that not been assigned storage allocation policies. In some embodiments, if a particular application has not been associated with a storage allocation policy, the compliance engine 166 does not monitor that particular application for storage allocation policy compliance.

In some embodiments, the compliance engine 166 checks to determine whether an application is using storage from the storage resource pool specified by the storage allocation policy. If the storage system 100 is using storage resources from a storage resource pool other than the storage resource pool specified in the storage allocation policy, the application is flagged, and an alert is generated.

The amount of storage currently being used by the application (usage value) is also checked relative to the amount of storage allocated to the application. The values are used to calculate a percentage used value, which is then compared with the yellow and red percentage capacity thresholds specified in the storage policy that has been assigned to the application. Based on the usage percentage, the compliance engine 166 determines if the application compliance value is green, yellow or red. In some embodiments, a usage percentage value below the yellow percentage capacity threshold is determined to be green, a usage percentage value above the yellow percentage capacity threshold but below the red percentage capacity threshold is determined to be yellow, and a usage percentage value above the red percentage capacity threshold is determined to be red. The application storage usage percentage values are stored with the timestamp of compliance check execution.

In some embodiments, if the previous measurement for the application was a better color (less bad traffic light color previously), a warning alert is raised to signal the worsening of the configuration. Thus, for example, if an application's storage usage was previously determined to be green, and is now yellow, an alert is generated. Similarly, when the application's storage usage transitions from yellow to red, an alert is generated. This enables alerts to only be generated when an application transitions between usage states, to minimize the number of alerts provided. Similarly, in some embodiments, if a previous measurement for the application to policy association was a worse color (worse traffic light color previously), an information alert can be raised to signal the improving of the configuration. This can occur, for example, if additional storage was added to an application since the last compliance check.

In some embodiments, when the compliance engine 166 determines that a particular application's storage usage percentage has exceeded a red percentage compliance threshold set by the storage policy applied to the application, an automatic storage allocation expansion is triggered. Depending on the expansion parameters set in the storage allocation policy, the expansion may occur automatically without system administrator authorization or upon receipt of authorization from the system administrator. For example, the storage expansion parameters may specify that storage expansion authorization is always required or is required after the occurrence of a specified number of storage expansion events. If expansion authorization is required always, or is required for this particular expansion event, in some embodiments, when a red compliance alert is sent to the system administrator, the red compliance alert may include a “proceed” option for the system administrator to choose if they want the automated expansion to start.

To implement an automated storage expansion, the amount of required additional storage is calculated based on the percentage of application size or a fixed amount (GB value), as specified in the policy. The required number of devices of the capacity defined in the policy device size property is calculated to add to the application, to give at least the amount of storage to the application that the policy defines. After the storage has been successfully added, the compliance algorithm is re-run to recalculate the compliance based on the new storage capacity and allocation.

FIG. 10 is a flow chart of an example method of detecting compliance of applications with assigned storage policies, and implementing automated storage allocation expansion events, according to some embodiments. The flow chart shown in FIG. 10 is implemented by compliance engine 166 periodically for each application being monitored by the compliance engine 166. The compliance engine may monitor applications running on a single storage system or may monitor applications running on multiple storage systems.

As shown in FIG. 10, at block 1000 an application is selected and a storage policy compliance check for the application is initiated. The compliance engine 166 reads the storage policy details for the application (block 1005) for example from one of the data structures described above in connection with FIGS. 3-4 and 5. The compliance engine 166 also reads the total storage capacity currently allocated to the application and the amount of storage being used by the application, and calculates the percentage of allocated storage being used by the application (block 1010).

The compliance engine 166 then compares the percentage of allocated storage that the application is currently using to the yellow and red policy percentage compliance thresholds specified in the storage policy for the application (block 1015). Because the red and yellow percentage compliance thresholds are specified in the particular storage policy applied to the application, different red and yellow percentage compliance thresholds may be specified for different applications, to enable the manner in which the applications are managed on the system to be individually specified.

In some embodiments, the compliance engine records the application compliance and capacity values (block 1020) and optionally updates a display (e.g. on user interface 162) with the current compliance and capacity values (block 1025). Block 1025 is optional, which is why it is shown in dashed lines on FIG. 10.

The compliance engine 166 then determines whether the current compliance value is different than a previous compliance value (block 1030). For example, if the previous compliance value was green, and the current compliance value is yellow, or if the previous compliance value was yellow, and the current compliance value is red, the compliance engine 166 will need to take further action in connection with the compliance check for this application.

Accordingly, as shown in FIG. 10, if the current compliance value is not different than the previous compliance value (a determination of NO at block 1030) the compliance check for this application ends, and the compliance engine 166 proceeds to implement a compliance check for another application 104.

If the current compliance value is different than the previous compliance value (a determination of YES at block 1030) the compliance engine determines whether the percentage of allocated storage currently being used by the application exceeds the red percentage compliance value specified for the application in the storage policy. If the percentage of allocated storage currently being used by the application does not exceed the red percentage compliance value (a determination of NO at block 1035) the compliance state change detected at block 1030 is associated with a transition from green compliance to yellow compliance. Accordingly, an alert is generated (block 1040) to notify the system administrator that the application has moved from green storage compliance to yellow storage compliance, and the compliance check for the application ends.

If the percentage of allocated storage currently being used by the application does exceeds the red percentage compliance value specified by the storage policy applied to the application (a determination of YES at block 1035) the compliance state change detected at block 1030 is associated with a transition from yellow compliance to red compliance, and an expansion event is required. Accordingly, the compliance engine 166 prepares the automated expansion parameters for the automated expansion process (block 1045). In some embodiments, an alert is also generated to notify the storage administrator of the compliance change (from yellow to red compliance) (block 1050). The alert, in some embodiments, includes a request for authorization to enable the automated expansion to occur, for example where user authorization for storage allocation expansion is specified as being required by the storage policy.

If no authorization is required, or if authorization is received, the compliance engine 166 implements the storage expansion (block 1055). In some embodiments, the compliance engine 166 calculates an amount of additional storage capacity required by the application, using the storage expansion parameters specified in the storage policy (block 1060). As noted above, the amount of storage required to be added during an automated expansion event, in some embodiments, is either a fixed increment or based on a percentage of the current amount of storage being used by the application. Once the amount of required additional storage is determined, the compliance engine 166 determines from the policy if the storage expansion should occur by adding additional devices to the application or by performing an on-line expansion of the existing devices (block 1065). The storage system management application then implements the expansion, for example by instructing the storage system operating system 150 to implement the required storage allocation on the storage system.

In some embodiments, once the additional storage has been allocated, the compliance engine 166 returns to block 1000 and re-runs the compliance check for this application (block 1070). By re-running the compliance check, the compliance engine is able to ensure that the storage system 100 has allocated the required storage and is able to verify that the application storage usage is below the red percentage capacity threshold specified in the storage policy applied to the application. If insufficient additional storage capacity was added during the previous automated expansion operation to bring the current storage usage percentage below the red percentage capacity threshold, additional automated storage expansion operations (blocks 1045-1065) can be used until the application storage usage drops below the red percentage capacity threshold specified by the storage policy.

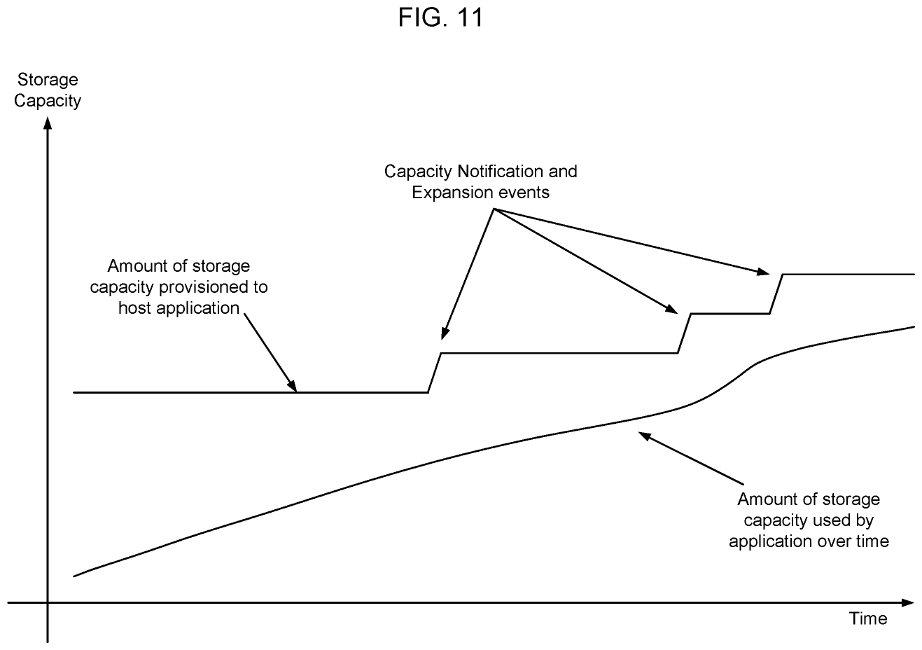

FIG. 11 is a graph of storage capacity vs time, showing a hypothetical application's 104 usage of storage on a storage system 100 and automatic expansion of the storage system's storage allocation, according to some embodiments. In some embodiments, each time the compliance check is run against an application, the results of the compliance check are recorded. In some embodiments, the recorded results include the used capacity and total allocated capacity for each application associated with a policy. The historical capacity usage, growth and subsequent expansion storage allocation for the application can be represented on a timeline using the saved datapoints from when the compliance checks are taken, for example as shown in FIG. 11.

As shown in FIG. 11, the amount of storage used by an application can increase over time. If the amount of storage allocated by the storage system doesn't increase, the application can run out of storage on the storage system which inhibits operation of the application. A given storage system may provide storage resources for hundreds or thousands of applications. A data center can have multiple storage systems 100. In this environment, monitoring storage allocations for potentially hundreds of thousands of applications quickly becomes infeasible. By standardizing application storage allocations using storage policies, monitoring compliance of application storage usage using the applied storage policies, and enabling the storage policies to specify how storage allocations should be expanded, it is possible for the storage system to intelligently manage storage allocations to proactively prevent applications assigned to the storage system from experiencing execution errors due to storage capacity problems.

By enabling the storage system to manage its own storage resources, and intelligently determine when additional storage resources are going to be required by each of its applications, it is possible to reduce the number of instances where applications are unable to continue execution due to having insufficient storage resources provisioned on the storage system. By proactively monitoring compliance with storage allocation policies, on a per-application basis, it is possible to prevent insufficient storage errors from interfering with application execution, thus increasing the reliability of the storage system and reducing the likelihood that one or more of the applications configured to use storage resources of the storage system will experience failure.

The methods described herein may be implemented as software configured to be executed in control logic such as contained in a CPU (Central Processing Unit) or GPU (Graphics Processing Unit) of an electronic device such as a computer. In particular, the functions described herein may be implemented as sets of program instructions stored on a non-transitory tangible computer readable storage medium. The program instructions may be implemented utilizing programming techniques known to those of ordinary skill in the art. Program instructions may be stored in a computer readable memory within the computer or loaded onto the computer and executed on computer's microprocessor. However, it will be apparent to a skilled artisan that all logic described herein can be embodied using discrete components, integrated circuitry, programmable logic used in conjunction with a programmable logic device such as a FPGA (Field Programmable Gate Array) or microprocessor, or any other device including any combination thereof. Programmable logic can be fixed temporarily or permanently in a tangible computer readable medium such as random-access memory, a computer memory, a disk drive, or other storage medium. All such embodiments are intended to fall within the scope of the present invention.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A non-transitory tangible computer readable storage medium having stored thereon a computer program for managing application storage resource allocations based on application specific storage policies, the computer program including a set of instructions which, when executed by a computer, cause the computer to perform a method comprising the steps of:
defining storage allocation policies for applications configured to use storage resources of a storage system, each storage allocation policy including storage type parameters, capacity monitoring parameters, and storage expansion parameters;
allocating storage resources, by the storage system to each of the applications, based on the storage type parameters of respective storage allocation policies for each application;
monitoring application storage usage compliance, by the storage system of each of the applications, based on the capacity monitoring parameters of the respective storage allocation policies for each application, to determine occurrence of the need for storage allocation expansion events for particular applications; and
upon determining the occurrence of the need for a storage allocation expansion event for a particular application, implementing a storage allocation expansion event for that particular application based on the expansion parameters of a respective storage allocation policy for that particular application.

2. The non-transitory tangible computer readable storage medium of claim 1, wherein the storage type parameters include a storage resource pool parameter specifying a group of the storage resources on the storage system from which storage is allocated to the particular application.

3. The non-transitory tangible computer readable storage medium of claim 1, wherein the storage type parameters include a device size parameter, specifying the size of devices to be created by the storage system for use by the particular application in connection with storage of data to the storage resources of the storage system.

4. The non-transitory tangible computer readable storage medium of claim 1, wherein the capacity monitoring parameters include a yellow percentage usage threshold and a red percentage usage threshold, the yellow percentage usage threshold specifying a percentage storage capacity usage value for generation of a notification, and the red percentage usage threshold specifying a percentage storage capacity usage value for implementation of an automated storage allocation expansion event for the particular application.

5. The non-transitory tangible computer readable storage medium of claim 1, wherein the expansion parameters include an expansion trigger parameter, specifying whether an storage allocation expansion event for the particular application is to be implemented automatically without user approval or whether the storage allocation expansion event for the particular application requires user approval after a predetermined number of prior storage allocation expansion events for that particular application.

6. The non-transitory tangible computer readable storage medium of claim 5, wherein the predetermined number of prior storage allocation expansion events is zero.

7. The non-transitory tangible computer readable storage medium of claim 1, wherein the expansion parameters include an expansion type parameter, specifying whether the storage allocation expansion event for the particular application should be implemented by adding additional storage devices or implementing an on-line expansion of existing storage devices to increase the size of the existing storage devices.

8. The non-transitory tangible computer readable storage medium of claim 1, wherein the expansion parameters include an expansion value, specifying whether the storage allocation expansion event for the particular application should be implemented by adding a fixed amount of additional storage or whether the storage allocation expansion event should be implemented by adding a percentage of a volume of storage currently being used by the particular application.

9. The non-transitory tangible computer readable storage medium of claim 1, wherein the step of monitoring application storage usage compliance comprises, for each monitored application:
retrieving storage policy details for the monitored application;
reading a value of storage capacity currently allocated to the monitored application;
reading a value of storage capacity currently being used by the monitored application;
using the storage capacity currently allocated to the monitored application and the value of storage capacity currently being used by the monitored application to determine a percentage of allocated storage capacity currently being used by the monitored application;
using the capacity monitoring parameters to determine a current compliance value of the monitored application; and
comparing the current compliance value with an earlier compliance value and generating an alert if the current compliance value is different than the earlier compliance value.

10. The non-transitory tangible computer readable storage medium of claim 9, further comprising using the current compliance value to determine the need for the storage expansion event.

11. A method of managing application storage resource allocations on a storage system based on application specific storage policies, the method comprising the steps of:
defining storage allocation policies for applications configured to use storage resources of a storage system, each storage allocation policy including storage type parameters, capacity monitoring parameters, and storage expansion parameters;
allocating storage resources, by the storage system to each of the applications, based on the storage type parameters of respective storage allocation policies for each application;
monitoring application storage usage compliance, by the storage system of each of the applications, based on the capacity monitoring parameters of the respective storage allocation policies for each application, to determine occurrence of the need for storage allocation expansion events for particular applications; and
upon determining the occurrence of the need for a storage allocation expansion event for a particular application, implementing a storage allocation expansion event for that particular application based on the expansion parameters of a respective storage allocation policy for that particular application.

12. The method of claim 11, wherein the storage type parameters include a storage resource pool parameter specifying a group of the storage resources on the storage system from which storage is allocated to the particular application.

13. The method of claim 11, wherein the storage type parameters include a device size parameter, specifying the size of devices to be created by the storage system for use by the particular application in connection with storage of data to the storage resources of the storage system.

14. The method of claim 11, wherein the capacity monitoring parameters include a yellow percentage usage threshold and a red percentage usage threshold, the yellow percentage usage threshold specifying a percentage storage capacity usage value for generation of a notification, and the red percentage usage threshold specifying a percentage storage capacity usage value for implementation of an automated storage allocation expansion event for the particular application.

15. The method of claim 11, wherein the expansion parameters include an expansion trigger parameter, specifying whether an storage allocation expansion event for the particular application is to be implemented automatically without user approval or whether the storage allocation expansion event for the particular application requires user approval after a predetermined number of prior storage allocation expansion events for that particular application.

16. The method of claim 15, wherein the predetermined number of prior storage allocation expansion events is zero.

17. The method of claim 11, wherein the expansion parameters include an expansion type parameter, specifying whether the storage allocation expansion event for the particular application should be implemented by adding additional storage devices or implementing an on-line expansion of existing storage devices to increase the size of the existing storage devices.

18. The method of claim 11, wherein the expansion parameters include an expansion value, specifying whether the storage allocation expansion event for the particular application should be implemented by adding a fixed amount of additional storage or whether the storage allocation expansion event should be implemented by adding a percentage of a volume of storage currently being used by the particular application.

19. The method of claim 11, wherein the step of monitoring application storage usage compliance comprises, for each monitored application:
retrieving storage policy details for the monitored application;
reading a value of storage capacity currently allocated to the monitored application;
reading a value of storage capacity currently being used by the monitored application;
using the storage capacity currently allocated to the monitored application and the value of storage capacity currently being used by the monitored application to determine a percentage of allocated storage capacity currently being used by the monitored application;
using the capacity monitoring parameters to determine a current compliance value of the monitored application; and
comparing the current compliance value with an earlier compliance value and generating an alert if the current compliance value is different than the earlier compliance value.

20. The method of claim 19, further comprising using the current compliance value to determine the need for the storage expansion event.
